(19) United States
(12) Patent Application Publication
(10) Pub. No.: US 2017/0142640 A1
(43) Pub. Date: May 18, 2017

(54) Inheritance of ANQP Elements

(71) Applicants: Qun Yang Lin, Beijing (CN); Jun Qing Xie, Beijing (CN); Xunteng Xu, Beijing (CN); Shuai Wang, Beijing (CN); Hewlett-Packard Development Company, L.P., Houston, TX (US)

(72) Inventors: Qun Yang Lin, Beijing (CN); Jun Qing Xie, Beijing (CN); Xunteng Xu, Beijing (CN); Shuai Wang, Beijing (CN)

(21) Appl. No.: 15/319,044

(22) PCT Filed: Jul. 7, 2014
(86) PCT No.: PCT/CN2014/081718

§ 371 Date: Dec. 15, 2016

(51) Int. Cl. H04W 48/14; H04W 48/16

(52) U.S. Cl. CPC H04W 48/14; H04W 48/16; H04W 84/12

(57) ABSTRACT

The present disclosure provides an ADV_server wherein the ADV server comprises a storage to store a set of root-zone ANQP elements; and a processor configured to: receive a request for an ANQP element from an AP agent; search the storage for the requested ANQP element; and send the requested ANQP element to the AP agent if the requested ANQP element is found in the storage; wherein the set of root-zone ANQP elements can be inherited by the AP agent as a child node of the ADV_server.

### BACKGROUND

Wi-Fi networks have become the most common wireless access network and are driving the dramatic increase of mobile data. More and. more users connect to the Internet via Wi-Fi networks, which can be easily deployed by the operators, enterprises, and even individual users. The Wi-Fi CERTIFIED Passpoint™ program—also referred to as Hotspot2.0 (HS2.0)—was proposed by Wi-Fi. Alliance to simplify and automate access to public Wi-Fi networks so that mobile users can have seamless roaming experiences, as in cellular networks.

The primary functions of HS2.0 Release 1 are auto-discovery, auto-selection and auto-connect, which require the implementation of Generic Advertisement Service (GAS)/Access Network Query Protocol (ANQP) protocol on both mobile devices and Access Points (AP). The GAS queries and responses can be formatted using a number of protocols, of which ANQP is the most commonly used.

However, each new AP has to be configured manually to support a multi-tier ANQP system. Furthermore, any updates to existing ANQP elements in the APs have to be downloaded from an access controller. This can result in significantly reduced scalability performance.

### BRIEF DESCRIPTION OF THE DRAWINGS

The disclosure is described in detail in the following description in. conjunction with the drawings. Features of the present disclosure are illustrated by way of non-limiting examples, in which:

FIG. 1 illustrates a block diagram of an ANQP system according to an example herein;

FIG. 2 illustrates a block diagram of an Advertisement Agent (ADV_agent) of the AP according to an example herein;

FIG. 3 depicts a block diagram of an Advertisement server (ADV_server) according to an example herein; and.

FIG. 4 depicts a flow chart of a method of operating an AP agent of the AP according to an example herein.

Throughout the drawings, identical reference numbers designate similar, but not necessarily identical, elements.

### DETAILE DESCRIPTION

In the disclosure, numerous details are set forth to provide an. understanding of the examples disclosed herein, However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the examples.

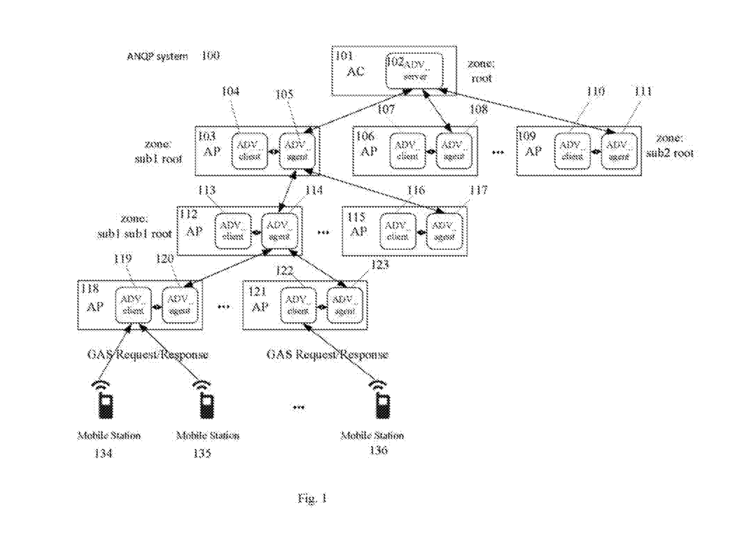

FIG. 1 illustrates a block diagram of an ANQP system 100 according to an example herein. The ANQP system 100 includes a server or an advertisement server (ADV_server) 102 and a plurality of APs 103, 106, 109, 113, 115, 118 and 121. The advertisement server 102 may be deployed on an access controller (AC) 101 or could be a standalone advertisement server, The advertisement server 102 maintains a set of root-zone ANQP-elements in. its storage device. The zone where the advertisement server 102 is located is called a root zone. The AC 101 manages a collection of APs (e.g., AP 103, AP 106, and AP 109) through the advertisement-Server 102 wherein the AC 101 is called a parent node and all the APs 103, AP 106 to AP 109 are called the child nodes of the parent node 101.

The collection of APs is categorized into at least two layers. The ANQP-elements of the AP in a sub-zone can be inherited from its parent node in the root zone. For example, the first layer of APs 103, 106 and 109 have their ANQP-elements inherited from the ADV_server 102. The second layer of APs, for example, AP 112, have their ANQP-elements inherited from the first layer of corresponding APs, for example, AP 103. The specific number of the total layers may depend on the specific deployment and/ or according to whether the APs in the specific layer have their own sub-zone ANQP information. In an example, there is only one layer of APs which inherit their ANQP-elements from ADV_server 102. Depending on the specific deployment, the total number of the lower layer of APs could be added wherein the new APs will inherit the ANQP-elements from the APs in their direct upper layer of APs, respectively.

The ANQP-elements of the APs in the sub-zone may have some customized configuration. For instance, in the sub-zone, the venue name may be configured with a more detailed address, for example, in case that the first layer of APs are located in the center of city and the second layer of APs are located in certain communities or streets, or shopping malls. If the second layers of APs are located in a sub-domain, then their domain name in the ANQP-elements could be set to the sub-domain name. It is optional to change the ANQP-elements which are inherited from the parent node.

Each AP includes an advertisement client (ADV_client) component and an advertisement agent (ADV_agent) component. APs 103, 106, 109, 112, 115, 118 and 121 include their respective ADV_client components 104, 107, 110, 113, 1.16, 119 and 122 and their respective ADV_agent components 1.05, 108, 111, 114, 117, 102 and 123. The ADV_agent and ADV client components in the same AP communicate with each other. Fore example, the ADV_agent 105 and the ADV_client 104 in the AP 103 communicate with each other. The APs in the neighboring layers communicates with each other through their respective ADV_agent copponents. For example, the AP 103 in the first layer communicates with AP 112 in the second layer by means of their respective ADV_agents 105 and 114.

The APs 103 and 109 are roots of two sub-zones (i.e., sub1.root and sub2.root) respectively. In the first layer of zone (i.e., sub1.root) with AP 103 as the root, the AP112 is configured as a root of a sub-zone (i.e., sub1.sub1.root), In such scenario, the deployment of the ANQP system 1.00 must be hierarchical to support zone-specified ANQP information (e.g., venue name, domain). Without adding extra devices, the ADV_agent component on each of APs can be implemented to support the hierarchical ANQP.

Each AP, for example, AP 118, can communicates with the mobile station, for example, the mobile station 134 through its ADV_client 119. The AP 112 for example communicates, through its ADV_agent component 114, with the upper layer of AP 103 which is located in the parent zone of the AP 112 or with the lower layer of AP 118 which is located in the child zone of the AP 112. The AP 103, which is located in the first layer of zone, communicates with ADV_server 102 through its ADV_agent 105. Note that the ADV_server 102 is at the top of the ANQP system 100. The mobile station as described herein may include any wireless device which can access the AP wirelessly, for example, the smart phone, the personal digital assistant or the smart tablet or the like.

Next, the working procedure of the ANQP system 100 is discussed in details, When the mobile station, which could be any one of the mobile stations 134, 135 and 136, needs to obtain the ANQP-elements, it sends a GAS request to the nearby APs. For example, the mobile station 134 sends the GAS request to the AP 118. After getting the GAS request sent from the mobile station 134, the ADV_client 119 of the AP 118 will communicate with its co-located ADV_agent 120 on the same AP 118 to fetch the ANQP-elements from the ADV_Agent 120. The AP receiving the GAS request herein could he located in any sub-zone, i.e. each AP provides the requesting mobile station with the requested ANQP-elements, because each AP includes both the ADV_client and ADV_agent components and can serve the nearby mobile stations. For example, the illustrated APs 103, 106, 109, 112, 115, 118 and 121 can receive the GAS request from the requesting mobile station near them and send the GAS response to the requesting mobile station. A mobile station may send the GAS request to some or all of APs in its vicinity.

After the ADV_agent 120 of the AP 118, for example, receives the query for the AMP elements from the ADV_client 119, it searches its database for the requested ANQP-elements. If it is determined that the database includes the requested ANQP-elements, then ADV_agent 120 obtains the ANQP-elements and send them back to the ADV_client 119. If it is determined that there are no requested ANQP-elements, then the ADV_agent 120 can respond to the ADV_client 118 with an ‘N/A’ notification directly. Alternatively, If it is determined that there are no requested ANQP-elements, the ADV_agent 120 forwards the query to its parent node. In this case, the parent node is the AP 1.1.2. The AP 112 will act similarly to the AP 118. If the AP receiving the request from the mobile station is located in the first layer of zone, for example, AP 103, then the parent node receiving the query from the ADV_agent is the ADV_server 102. If the AP receiving the request from the mobile station is located in the second or lower layer of zone, for example, AP 112 or AP 118, then the parent node receiving the query from the ADV_agent is its parent AP in the direct upper layer of zone, for example, AP 103 or AP 112. If the ADV_Server 102 or the ADV_agent 106 in the upper layer of zone receiving the query from the lower layer of AP 112, then it triggers an ANQP synchronization between the parent AP and its child AR In another example, if the ADV_agent 105 in the first layer of AP 103 for example does not find the requested ANQP-elements in the database of the AP 103, then it also may forward the query to the ADV_server 102.

After the ADV_client 119 in AP 118 for example gets the response including the ANQP-elements from the ADV_agent 120 of the same AP 118, the AP 118 will send the GAS response to the requesting mobile station 134 for example through its ADV_client 119.

In another example, the hierarchical deployment of the ANQP system 100 as above described can be applied in autonomous scenario where when no AC 101 or extra ADV_server 102 is deployed in the HS2.0 system, the ADV_agent 106 of the AP 103 for example can be configured to function as the ADV_server.

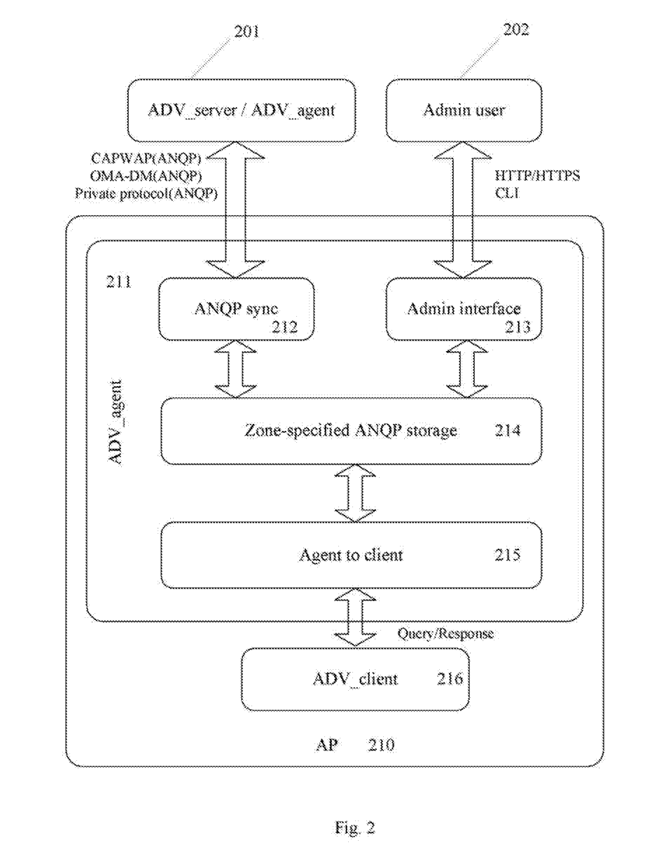

FIG. 2 illustrates a block diagram of an ADV_agent 211 of the AP 210 according to an example herein. The AP 210 includes the ADV_client component 216 and the ADV_agent component 211. The ADV_client 216 interacts with the mobile station to receive the request from the mobile station and send back the corresponding response to the mobile station. The ADV_agent 211 interacts with the ADV_Client 216 to receive, from the ADV client 216, the request sent by the mobile station and returns the response to the ADV_client 216. The ADV_agent 211 also interacts with the ADV-server 201 or the ADV-agent 201 in the upper layer of AP to obtain the requested ANQP-elements. In an example, the ADV_agent 211 also interacts with an administration user 202 so that the ANQP-elements inherited from the upper layer of AP 201 could be customized through an administration interface module 213. In an example, the administration. user 202 could input other information, for example, specific to the AP 210.

The ADV agent 211 shown in FIG. 2 includes at least an ANQP synchronization module 212, a zone-specified ANQP storage 214, the administration interface module 213 and. an Agent-to-Client module 215. The ANQP synchronization module 212 can communicate with the ADV_agent or ADV_server 201 of the parent zone to fetch the requesting ANQP-elements. The communication between them may be mad by means of Control And Provisioning of Wireless Access Points (CAPWAP), Open. Mobile Alliance Device Management (OMA-DM) or private protocol for example. If there is an update of the existing ANQP-elements in the AP 201 in the parent zone, update messages can either be proactively pushed from the AP 201 of the parent zone to ADV_agent 211. In another example, the ANQP synchronization module 212 may inquiry the AP or ADV_server 201 for any update of the existing ANQP-elements and if any, then the update messages can be pulled by the ANQP synchronization module 212 into the storage module named Zone-specified ANQP storage from the ADV_Server or ADV_Agent 201. After the ANQP elements are updated, the ADV_agent 211 also further pushes the updated ANQP elements to the lower layer of AP or could be pulled by the ADV_Agent in the next lower layer of AP similarly.

In an example, the ADV_agent 211 may manage a plurality of AP agents as its child nodes, for example, periodically checking the operation status of the child AP agents, testing the links between them. When there is a client asking to join in the child AP, the ADV_agent 211 will check its account or its permission and then inform the child AP of whether to approve the client or not. In another example, when a new child AP joins in the hierarchical ANQP system, it needs to obtain permission. from the the ADV_agent 211.

The Administration interface module 213 shown in FIG. 2 can be used by the Administration user(s) 202 to configure or customize the ANQP-elements in the ADV_agent 211. For instance, this interface module 213 can provide the administration user 202 with a web page to view or modify the ANQP-elements in the ADV_agent 211, for example, relating to the venue name or domain name. The configured, customized or modified ANQP-elements are saved into the Zone-specified ANQP storage 214. The changed ANQP elements can be synchronized to the lower layer of APs.

The Zone-specified ANQP storage module 214 in FIG. 2 receives the ANQP-elements from both the ANQP synchronization and Administration interface modules 212 and 213, and saves the information in the storage 214. The storage 214 for storing the ANQP element or other information may be a database (DB), a file, or the other means. When the Zone-specified ANQP storage module 214 receives an inquiry for the ANQP elements from the the Agent-to-client module 215, it sends back ANQP lookup results to the agent-to-client module 215 if any.

The agent-to-client module 215 in FIG. 2 receives the ANQP query message from the co-located ADV_client 216 of the AP 210. Afterwards, the agent-to-client module 215 parses the message and then looks up the ANQP-elements in the Zone-specified ANQP storage 214. If there are no requested ANQP-elements in the storage 214, then the agent-to-client module 215 can either respond to the ADV_client 216 with an ‘N/A’ notification directly or forward the query to its parent node. Alternatively, if there are the requested ANQP elements, then the agent-to-client module 215 constructs a response message including the requested ANQP elements according to the lookup result and sends the message to the ADV_client 216. After the ADV_client 216 receives the message, it then sends a corresponding ANQP-encoded GAS response to the requesting mobile station.

Next, the external interfaces of ADV_agent 211 will be described. The ADV_agent 211 can communicate with the ADV_agent or ADV_server 201 in its parent zone through the ANQP synchronization module 212 to fetch the ANQP-elements. In an example, if there are no requested ANQP elements in the ADV_agent 211, then the ADV_agent 211 fetch the requested ANQP elements through the ANQP synchronization module 212. The communication between them may be made by using any appropriate communication protocols. The communication protocols can be an extension based on the CAPWAP, OMA-DM or any other feasible protocols supporting pull and push mode for information exchange. If there is an update of the existing ANQP-elements in the ADV_server or ADV_agent 201 in the AP in the parent zone, update messages can either be proactively pushed from the ADV_server or ADV_agent 201 to the ADV_agent 211 by using any of these protocols as described herein. The Administration interface module 212 shown in FIG. 2 can be used by the Administration user(s) 202 to configure or customize the ANQP-elements in the ADV_agent 211. The communication between the administration user 202 and the Administration interface module 213 can be implemented using Web portal, command line interface (CLI) or any other methods.

The communication between the agent-to-client module 215 and the ADV_client 216 (i.e. between ADV client 216 and ADV_agent 211) may be implemented via a function call, socket IO, or any other process/thread communication mechanisms.

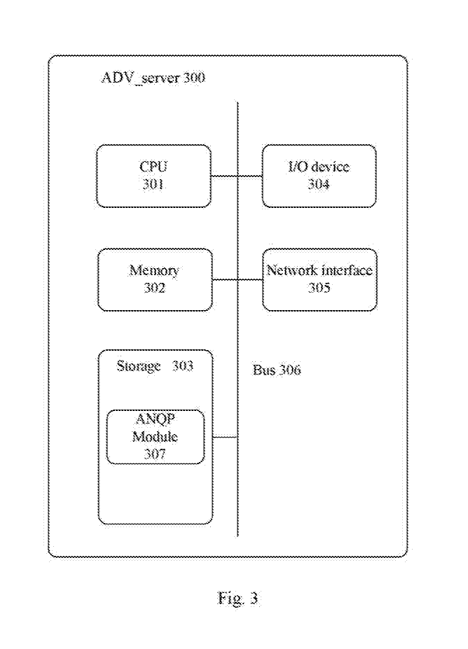

FIG. 3 depicts a block diagram of the ADV_server 300 according to an example herein. As above stated, the ADV_server 300 can be implemented in the AC controller or can be a standalone server. The ADV_server 300 can be also integrated with other system or server. For example, as shown in FIG. 3, the ADV_server 300 includes one or more processor (s) CPU 301, an associated memory 302 (e.g., random access memory (RAM), cache memory, flash memory, etc.), a storage device 303 (e.g., a hard disk, an optical drive such as a compact disk drive or digital video disk (DVD) drive, a flash memory stick, etc.), I/O devices 304 such as a keyboard, a mouse, a microphone (not shown) or a monitor and a network interface 305, which couple with each other with a bus 306.

The administration user may use the I/O devices 304 to generate or create a set of ANQP elements for the root zone. The generated set of ANQP elements may be temporarily stored in the memory 302 and finally stored in the storage device 303, in particular, in the ANQP module 307 in the storage device 303. The memory 302 contains, among others, machine readable instructions which, when executed by the processor 301, cause the processor to store the generated set of ANQP elements into the storage device 302 or implement other functions for deployment of the hierarchical ANQP system.

The ADV_server 300 receives the request for the ANQP elements from its child node, the AP agent, via the network interface 305. Upon receipt of the request, the ADV_server 300 searches the storage device 307, in particular, ANQP module 307, for the requested ANQP elements and then sends the requested ANQP element to the requesting AP agent if the requested ANQP element is found in the storage device 303. If there are no requested ANQP elements, they need to be generated by the administration user and then be sent to the requesting AP agent.

The ADV_server 300 can be used by the administration user to configure or modify the existing ANQP elements in the storage device 307. In an example, if there is any change in the existing ANQP elements, then the ADV_server 300 pushes update messages relating to the change to its child nodes, the AP agent so as to make the ANQP elements synchronized between them. Alternatively, the AP agent as its child node proactively pulls the changed ANQP elements to its own Zone-specified ANQP storage.

In an example, when a new AP is deployed in the hierarchical ANQP system and informs the ADV_server 300 for example, via the network interface 305, the ADV_server 300 can send or push the existing ANQP elements to the new AP as a. response so that the new AP can inherit all the existing ANAP elements from the ADV server 300. Alternatively, the new AP can proactively pull the existing ANQP elements from the ANQPA server 300 and then inherit them.

The ADV_server 300 also may manage a plurality of AP agents acting as its child nodes, for example, periodically checking the operation. status of the AP agents, testing the links between them. In case that there is a client asking to join in the child AP, the ADV_server 300 will check its account or its permission and then inform the child AP of whether to approve the client or not. In another example, when a new child AP joins in the hierarchical ANQP system, it obtains operation permission from the ADV_server 300.

In an autonomous example where no specific AC or extra. ADV_server is deployed in the HS2.0 system, all the functionality of the ADV_server 300 will be implemented by the AP. The AP including the ADV-agent acting as the ADV_server is selected from all the APs in the first layer of APs. Alternatively, one of the APs is designated to act as the ADV_server by default.

In the case that the ADV_server 300 fails, the functionality of the ADV_server is replaced with one of the plurality of AP agents. The AP acting as the ADV_server 300 could be predetermined in advance or selected by default.

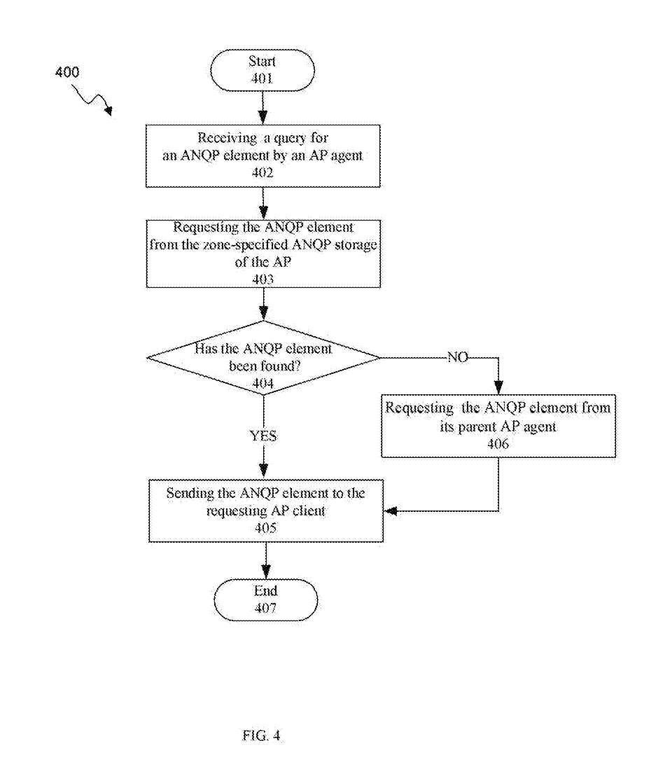

FIG. 4 depicts a flow chart of a method 400 of operating an AP agent of an AP according to an example herein. The depicted method 400 may be carried out by execution of sequences of executable instructions, In an example, the executable instructions are stored in a tangible machine readable storage medium. The method 400 may be carried out by a processor in the AP or any other suitable element of the AP.

The method 400 begins with the block 401. Then, the method 400 goes to the block 402 where the AP agent receives a query for the ANQP elements from the requesting mobile station through its AP client module. Next, the method 400 goes to the block 403 where the AP agent requests the enquired ANQP elements from its zone-specified ANQP storage module through its Agent-to-client module. Then, the method goes to the block 404 where the zone-specified ANQP storage module checks its file or database for the requested ANQP elements. If it is determined that the file or database includes the requested AlQP-elements, then it obtains the ANQP-elements and sends them back to the AP client at block 405.

If it is determined that there are no requested ANQP-elements, then the method branches to the block 406 where the AP agent forwards the query to its parent. AP agent. As above described, the parent AP agent could be the AP server if the AP receiving the request from the mobile station is located in the first layer of zone, otherwise, the parent AP agent is the AP agent in the upper layer of AP. After the AP agent receives the requested ANQP elements from its parent AP agent, then the method goes to the block 405, Then, the method ends at the block 407.

In an example, the AP agent inherits all the ANQP elements from its parent AP agent or the AP server. In another example, the method could further include the action that if there is a change in any one of a plurality of ANQP elements in the parent AP agent, the AP agent receives the changed ANQP element from its parent AP agent. The change may take place, for example, when the existing ANQP elements are modified or configured into new values by the administration user(s) or when new ANQP elements are generated by the administration user (s).

In another example, the method could further include the action that if the parent AP agent fails, then the AP agent as its child node is configured. to act as the parent AP agent. In an example, the AP agent acting as the parent AP agent could be selected by default.

In another example, the method could further include the action that the AP agent is configured by the administration user through the administration interface to change at lease one of the ANQP elements as included in the AP agent. In an example, the administration interface may provide the administration user with the web page to configure the at least one of the plurality of ANQP elements.

While the disclosure has been described with respect to a limited number of example embodiments, those skilled in the art, having benefit of this disclosure, will appreciate that other example embodiments can be devised which do not depart from the scope of the disclosure as disclosed herein. Accordingly, the scope of the disclosure should be limited only by the attached claims.

1. An ADV_server, comprising:
a storage to store a set of root-zone Ah QP elements; and
a processor configured to:
receive a request for an ANQP element from an AP agent;
search the storage for the requested ANQP element; and
send the requested ANQP element to the AP agent if the requested ANQP element is found in the storage;
wherein the set of root-zone ANQP elements can be inherited by the AP agent as a child node of the ADV_server.

2. The ADV_server according to claim 1, wherein the ADV_server is configured to manage a plurality of AP agents as its child nodes.

3. The ADV server according to claim 2, wherein
a functionality of the ADV_server is replaced with one of the plurality of AP agents in the event that the ADV_server fails.

4. An ANQP AP agent comprising:
an ANQP synchronization module to fetch an ANQP element from a high layer of the ANQP AP agent, wherein the high layer of the ANQP AP agent operates as a parent node and wherein the parent node includes a plurality of ANQP elements;
a zone-specified ANQP storage to store the plurality of ANQP elements which are inherited from the parent node;
an Agent-to-Client module to, upon receipt of a query for one of the ANQP elements by an AP client, request the one of the ANQP elements from the zone-specified ANQP storage and then return the requested ANQP element to the AP client.

5. The ANQP AP agent according to claim 4, wherein the parent node is an ADV_server which is located in a parent zone of the ANQP AP agent.

6. The ANQP AP agent according to claim 4, further comprising:
an Administration interface module to receive a configured ANQP element and store the configured ANQP element into the zone-specified ANQP storage.

7. The ANQP AP agent according to claim 4, wherein
the plurality of ANQP elements are inherited by a child AP agent of the ANQP AP agent.

8. The ANQP AP agent according to claim 4, wherein the ANQP AP agent is a component of an AR

9. The ANQP AP agent according to claim 8, wherein the AP further includes the AP client configured to send the query from a mobile device to the AP agent.

10. The ANQP AP agent according to claim 4, wherein the ANQP AP agent is configured to manage at least one child ANQP AP agent.

11. An ANQP method comprising:
receiving by an AP agent a query for an ANQP element;
requesting from a zone-specified ANQP storage of the AP agent the ANQP element;
if the requested ANQP element is found in the zone-specified ANQP storage, then sending it to an requesting AP client;
otherwise, requesting by the AP agent the requested ANQP element: from its parent AP agent or responding to the requesting AP client with ‘N/A’ notification;
wherein the AP agent as a child AP agent inherits a plurality of ANQP elements from its parent AP agent .

12. The ANQP method according to claim 12, further comprising:
if there is a change in any one of a plurality of ANQP elements in the parent AP agent, receiving the changed ANQP element at the AP agent from its parent AP agent.

13. The ANQP method according to claim 12, further comprising:
if there is a change in any one of a plurality of ANQP elements in the parent AP agent, then the AP agent pulls the changed ANQP element from. its parent AP agent.

14. The ANQP method according to claim 11, further comprising:
receiving instructions at the AP agent, from an Administration user via an Administration interface, to configure at least one of the plurality of ANQP elements.

15. The ANQP method according to claim 14, wherein the Administration interface provides the Administration user with a web page to configure at least one of the plurality of ANQP elements
